(19) United States
(12) Patent Application Publication
(10) Pub. No.: US 2025/0113966 A1
(43) Pub. Date: Apr. 10, 2025

(54) PROPULSION SYSTEM FOR CLEANING MACHINES

(71) Applicant: Nilfisk A/S, Broendby (DK)

(72) Inventors: Thomas J. Suelflow, Woodbury, MN (US); Kurt Vetse, Maple Grove, MN (US); Stephen Klopp, Champlin, MN (US)

(73) Assignee: Nilfisk A/S, Broendby (DK)

(21) Appl. No.: 18/377,033

(22) Filed: Oct. 5, 2023

(51) Int. Cl. A47L 11/40; A46B 9/02; A46B 13/00; A46B 13/02; A47L 11/24; A47L 11/293; B60K 1/00; B60K 1/02

(52) U.S. Cl. CPC A47L 11/4066; A46B 9/025; A46B 9/026; A46B 13/001; A46B 13/008; A46B 13/02; A47L 11/24; A47L 11/293; A47L 11/4016; A47L 11/4038; A47L 11/4041; A47L 11/4072; A47L 11/4083; B60K 1/02; A46B 2200/3033; B60K 2001/001

(57) ABSTRACT

A cleaning machine for cleaning along an intended direction of use includes a drive assembly, a cleaning element, and a multi-directional wheel. The Drive assembly includes a motor and a pair of drive wheels operable connected to the motor. Each wheel of the pair of wheels can be configured to be driven independently of the other wheel. The cleaning element can be disposed forward of the pair of drive wheels along the intended direction of use of the cleaning machine. The multi-directional wheel disposed forward along the intended direction of use of the pair of drive wheels. The multi-directional wheel can define a pivot axis and can be configured to swivel about the pivot axis in a range of direction extending 360°.

### BACKGROUND

The present disclosure generally relates to cleaning machines. In particular, the present disclosure relates to a propulsion system for a cleaning machine.

With some existing cleaning machines, a single rear drive/steered wheel is utilized due to the placement of a broom and a debris hopper for sweeping functionalities. In such examples, the front wheels of some existing cleaning machines are fixed and unable to rotate. Such designs can require operators to adjust to a different type of driving experience than the operator is accustomed to. Additionally, such single rear wheel designs can limit the cleaning capabilities of the cleaning machine with respect to types and positioning of cleaning implements.

The inventors have recognized that there is a need for an improved system that overcomes the aforementioned disadvantages of cleaning machines with single wheel configurations.

### SUMMARY

A cleaning machine for cleaning along an intended direction of use includes a drive assembly, a cleaning element, and a multi-directional wheel. The Drive assembly includes a motor and a pair of drive wheels operable connected to the motor. Each wheel of the pair of wheels can be configured to be driven independently of the other wheel. The cleaning element can be disposed forward of the pair of drive wheels along the intended direction of use of the cleaning machine. The multi-directional wheel disposed forward along the intended direction of use of the pair of drive wheels. The multi-directional wheel can define a pivot axis and can be configured to swivel about the pivot axis in a range of direction extending 360°.

A propulsion system for a cleaning machine with a cleaning element can include a driving assembly and a multi-directional wheel. The driving assembly can be disposed rearward of the cleaning element of the cleaning machine along an intended direction of use of the cleaning machine. The driving assembly can include a motor and a pair of drive wheels operably connected to the motor. Each wheel of the pair of drive wheels can be configured to be driven independently of the other drive wheel. The multi-directional wheel can be disposed forward along the intended direction of use of the cleaning machine of the pair of drive wheels. The multi-directional wheel can define a pivot axis and can be configured to swivel 360° about the pivot axis.

### BRIEF DESCRIPTION OF THE DRAWINGS

FIG. 1A shows a perspective view of a block model of a first cleaning machine with two multi-directional wheels.

FIG. 1B shows a bottom view of the block model of the first cleaning machine.

FIG. 2A shows a perspective view of a block model of a second cleaning machine with a single multi-directional wheel.

FIG. 2B shows a bottom view of the block model of the second cleaning machine.

FIG. 3A shows a perspective view of a block model of a third cleaning machine with two different cleaning elements.

FIG. 3B shows a bottom view of the block model of the third cleaning machine.

FIG. 4 shows a bottom view of the third cleaning machine with a reduced hopper opening.

### DETAILED DESCRIPTION

With existing cleaning machines, sweepers and combination cleaning machines can include rear propulsion/steer designs requiring operators to adjust to a different type of driving experience (e.g., rear steer) than would normally be experienced on a vehicle such as a car. The inventors have recognized, among other things, that a problem to be solved with existing cleaning machines is eliminating the single rear wheel setup which can limit the types and number of configurations of cleaning implements the cleaning machine can utilize.

The proposed disclosure presents a new design for a cleaning machine propulsion and steering system with controlled rear drive wheels and a pair of front caster wheels. The independently controlled rear drive wheels provide both propulsion and steering for the cleaning machine. The present disclosure also includes a pair of front casters wheels, both of which are non-driven and are configured to rotate 360°.

The embodiments disclosed herein enable steering functionality that more closely resembles typical steered arrangements such as in vehicles. Additionally, such a propulsion and steering system provides a platform that can be used across various machines and various machine types. In this way, the embodiments of the present disclosure help to reduce part counts and to streamline assembly across multiple product lines.

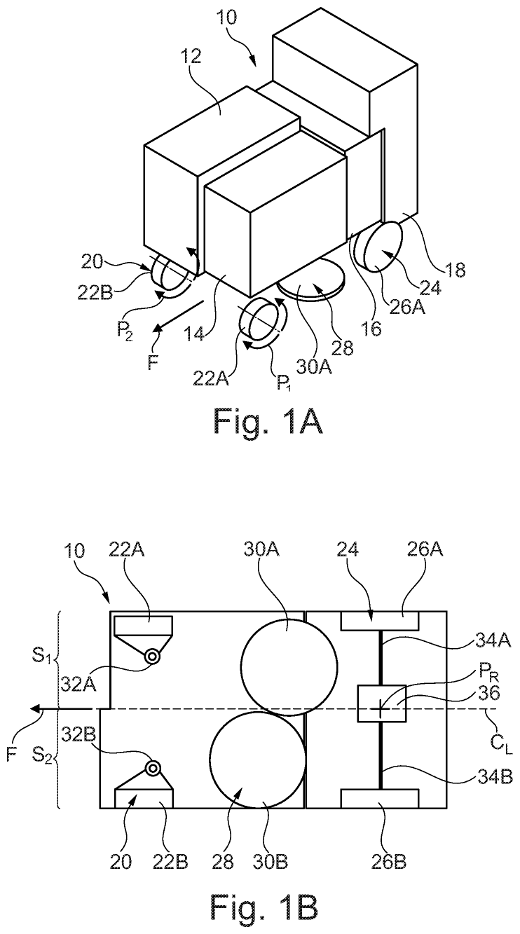

FIG. 1A shows a perspective view of a block model of first cleaning machine 10 with operator area 12, power source 14, solution tank 16, recovery tank 18, front wheel assembly 20 (with first front wheel 22A and second front wheel 22B), rear wheel assembly 24 (with first rear wheel 26A) and cleaning assembly 28 (with first cleaning element 30A). FIG. 1A also includes forward direction F which represents an intended direction of use of first cleaning machine 10. FIG. 1B shows a bottom view of the block model of first cleaning machine 10 with front wheel assembly 20 (with first front wheel 22A, first pivot 32A, second front wheel 22B, and second pivot 32B), rear wheel assembly 24 (with first rear wheel 26A and second rear wheel 26B), cleaning assembly 28 (with first cleaning element 30A and second cleaning element 30B), first rear axle 34A, second rear axle 34B, and drive unit 36. FIGS. 1A and 1B are discussed in tandem.

In an embodiment, first cleaning machine 10 is at least one of a sweeper machine, a vacuum machine, a scrubber machine, or a combination thereof. As shown in FIG. 1A, first cleaning machine 10 is a ride-on machine configured for a user to sit somewhere on the machine. In other embodiments, first cleaning machine 10 can include at least one of a ride-on machine, stand-on machine, a walk-behind, or a combination thereof.

Operator area 12 is a space or opening configured to contain a user during use of first cleaning machine 10. Power source 14 is a source of power. In an embodiment, power source 14 can include at least one of an engine, a motor, a battery, or a combination thereof. Additionally or alternatively, power source 14 can include removeable or replaceable components such as one or more batteries. Solution tank 16 and recovery tank 18 are receptacles configured for the containment of a liquid. In an embodiment, solution tank 16 can include at least a clean water section, a cleaning solution section, or a combination thereof. In an embodiment, recovery tank 18 is a tank for containing waste liquid or recovery liquid.

Front wheel assembly 20 is an assembly of one or more wheels. In this embodiment, front wheel assembly 20 is shown to include first front wheel 22A and second front wheel 22B. In other embodiments, front wheel assembly 20 can include a single wheel or more than two wheels. In an embodiment, at least one of first front wheel 22A and second front wheel 22B can be a multi-directional wheel. For example, at least one of first front wheel 22A and second front wheel 22B can be a caster wheel, a swivel caster, an omni-directional wheel, or a combination thereof.

Rear wheel assembly 24 is an assembly of one or more wheels. In an embodiment, rear wheel assembly 24 can include two wheels such as first rear wheel 26A and second rear wheel 26B (e.g., shown in FIG. 1B). First rear wheel 26A and second rear wheel 26B can be a pair of drive wheels. In an embodiment, at least one of first rear wheel 26A, second rear wheel 26B, or a combination thereof can be a drive wheel.

Cleaning assembly 28 includes one or more components configured for cleaning a surface. In an embodiment, cleaning assembly 28 can include two cleaning elements such as first cleaning element 30A and second cleaning element 30B (e.g., shown in FIG. 1B). In an embodiment, at least one of first cleaning element 30A, second cleaning element 30B, or a combination thereof can include at least one of a brush, a sweeping element, a scrubber, a burnisher, a sanding element, or a combination thereof. In an embodiment, first cleaning elements can include at least one of a disc, a pad, a cylinder, or a combination thereof. Additionally or alternatively, at least one of first cleaning element 30A, second cleaning element 30B, or a combination thereof can be configured to move in a at least one of a rotational motion, an orbital motion, or a combination thereof.

In an embodiment, both of first pivot 32A and second pivot 32B can be at least one of a rod, a pivot axis, a pivot rod, a vertical axis (e.g., extending into and out of the page as shown in FIG. 1B), or a combination thereof. In an embodiment, both of first rear axle 34A and second rear axle 34B can be a rod, a spindle, or a combination thereof. Drive unit 36 can include at least one of a motor, a transmission, a gear assembly, a battery, an engine, or a combination thereof. Additionally or alternatively, drive unit 36 can include first and second motors operably connected to first rear axle 34A and second rear axle 34B, respectively.

Each of operator area 12, power source 14, solution tank 16, recovery tank 18, front wheel assembly 20, rear wheel assembly 24, and cleaning assembly 28 are operably connected to one another. In this embodiment, operator area 12, power source 14, solution tank 16, recovery tank 18, front wheel assembly 20, rear wheel assembly 24, and cleaning assembly 28 are positioned relative to one another in a first configuration. In other embodiments, at least one of operator area 12, power source 14, solution tank 16, recovery tank 18, front wheel assembly 20, rear wheel assembly 24, and cleaning assembly 28 can be located in a different position or orientation relative to another part or piece of first cleaning machine 10. Additionally or alternatively, at least one of operator area 12, power source 14, solution tank 16, recovery tank 18, front wheel assembly 20, rear wheel assembly 24, and cleaning assembly 28 can be connected or mounted to a frame or platform of first cleaning machine 10.

Additionally or alternatively, at least one of operator area 12, power source 14, solution tank 16, recovery tank 18, front wheel assembly 20, rear wheel assembly 24, cleaning assembly 28, or a combination thereof can be configured in a modular manner. In this embodiment, operator area 12 can be disposed forward of rear wheel assembly 24 along forward direction F of use of first cleaning machine 10. Alternatively, operator area 12 can be disposed rearward of rear wheel assembly 24 along forward direction F of use of first cleaning machine 10.

In an embodiment, at least one of first front wheel 22A and second front wheel 22B, or a combination thereof can be disposed forward along forward direction F of first cleaning machine 10 of rear wheel assembly 24. In another embodiment, at least one of first front wheel 22A and second front wheel 22B can be positioned on or near a front of first cleaning machine 10 (e.g., with the front of first cleaning machine 10 being disposed towards the left in FIGS. 1A and 1B). First front wheel 22A and second front wheel 22B can be positioned on opposite sides of and at approximately equal distances to centerline C_{L} of first cleaning machine 10 (see e.g., FIG. 1B). For example, first front wheel 22A can be disposed on first side S₁ of first cleaning machine 10. Additionally, second front wheel 22B can be disposed on second side S₂ of first cleaning machine 10.

In an embodiment, both of first front wheel 22A and second front wheel 22B of front wheel assembly 20 can be free to rotate 360°. In another embodiment, first front wheel 22A and/or second front wheel 22B can be configured to at least one of pivot, swivel, or a combination thereof about a respective vertical axis (e.g., up-and-down as shown in FIG. 1A). For example, as shown in FIG. 1B, first front wheel 22A can pivot or swivel about first pivot 32A. Additionally or alternatively, second front wheel 22B can pivot or swivel about second pivot 32B. In FIG. 1A, a direction of pivot or swivel of first front wheel 22A and second front wheel 22B can be identified by arrows P₁ and P₂, respectively. Additionally, first front wheel 22A and second front wheel 22B can support a weight of the front of first cleaning machine 10. In an embodiment, at least one of first front wheel 22A and second front wheel 22B can be a non-steered wheel. In another embodiment, at least one of first front wheel 22A and second front wheel 22B can be a steered wheel.

In an embodiment, first rear wheel 26A can be operably connected to drive unit 36 via first rear axle 34A and/or second rear wheel 26B can be operably connected to drive unit 36 via second rear axle 34B. In an embodiment, each wheel of first rear wheel 26A and second rear wheel 26B can be configured to be driven independently of the other rear wheel. For example, each wheel of first rear wheel 26A and second rear wheel 26B can be driven at different rates and/or directions of rotation to cause movement and/or turning of first cleaning machine 10. In an embodiment, the relative positioning between and the drive functionality of first rear wheel 26A and second rear wheel 26B can cause first cleaning machine to rotate about rotation point P_{R} that is defined by rear wheel assembly 24. In an embodiment, rotation point P_{R} can be disposed at an intersection of centerline C_{L} of first cleaning machine 10 and at least one of a rotational axis of first rear axle 34A or a rotational axis of second rear axle 34B.

In an embodiment, first rear axle 34A and second rear axle 34B can be aligned coaxially relative to each other. In another embodiment, first rear axle 34A and second rear axle 34B can be misaligned or offset along at least one of a forward-to-backward direction (e.g., left-to-right as shown in FIG. 1B) or a bottom-to-top direction (e.g., into and out of the page as shown in n FIG. 1B) of first cleaning machine 10.

Additionally or alternatively, cleaning assembly 28 can be disposed forward along forward direction F of first cleaning machine 10 of rear wheel assembly 24. In another embodiment, front wheel assembly 20 can be disposed forward along forward direction F of first cleaning machine 10 of cleaning assembly 28. Cleaning assembly 28 (with at least one of first cleaning element 30A and second cleaning element 30B) is configured to at least one or clean, scrub, burnish, polish, sweep, vacuum, or a combination thereof a surrounding environment such as a floor upon which first cleaning machine 10 is disposed.

First cleaning machine 10 with front wheel assembly 20 and rear wheel assembly 24 presents an independently controlled dual rear-drive wheel configuration that provides both propulsion and steering for first cleaning machine 10. With rear wheel assembly 24 causing first cleaning machine to rotate about rotation point P_{R}, the combination of front wheel assembly 20 and rear wheel assembly 24 enables steering functionality that more closely resembles typical steered arrangements involving front-steered wheels. Additionally, first front wheel 22A and second front wheel 22B (e.g., caster or omni-directional wheels) are utilized in the front of the cleaning machine to support the weight of the front of the machine. In view of these features, first cleaning machine 10 gives an operator a sensation of utilizing a more familiar front-steered machine configuration.

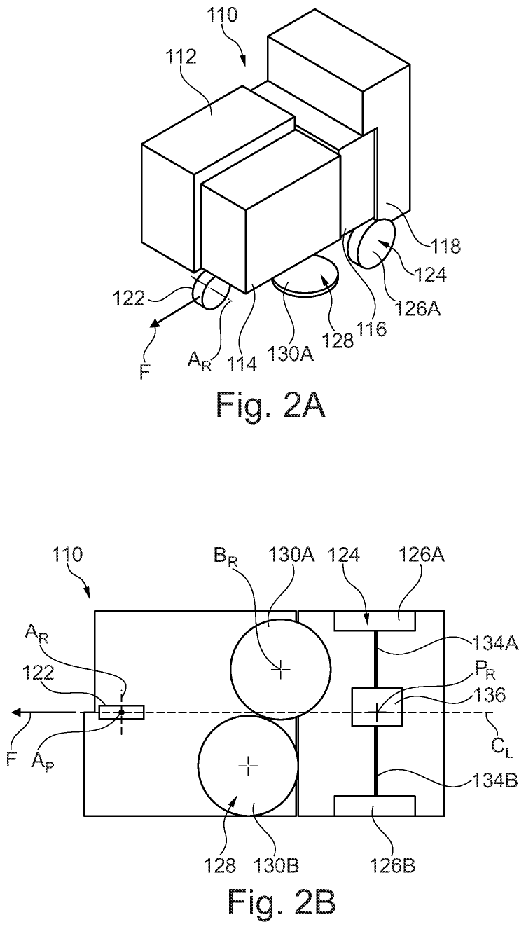

FIG. 2A shows a perspective view of a block model of second cleaning machine 110 with operator area 112, power source 114, solution tank 116, recovery tank 118, front wheel 122 (including rotational axis A_{R}), rear wheel assembly 124 (with first rear wheel 126A) and cleaning assembly 128 (with first cleaning element 130A). FIG. 2A also includes forward direction F which represents an intended direction of use of second cleaning machine 110. FIG. 2B shows a bottom view of the block model of second cleaning machine 110 with front wheel 122 (including rotational axis A_{R} and pivot axis A_{P}), rear wheel assembly 124 (with first rear wheel 126A and second rear wheel 126B), cleaning assembly 128 (with first cleaning element 130A and second cleaning element 130B), first rear axle 134A, second rear axle 134B, and drive unit 136. FIGS. 2A and 2B are discussed in tandem.

As discussed herein, descriptions of components of second cleaning machine 110 correspond to the same or similar components of first cleaning machine 10 as discussed with the respect to FIGS. 1A and 1B. In view of this, components of second cleaning machine 110 are denoted with character reference numerals that are 100 more than the same or similar elements of first cleaning machine 10 (first cleaning machine 10 and second cleaning machine 110, operator area 12 and operator area 112, . . . , drive unit 36 and drive unit 136, etc.). In this way, descriptions provided with respect to first cleaning machine 10 can also describe the corresponding elements of second cleaning machine 110 shown in and discussed with respect to FIGS. 2A and 2B.

Second cleaning machine 110 can include front wheel 122. In an embodiment, front wheel 122 can be a multi-directional wheel. For example, front wheel 122 can be a caster wheel, a swivel caster, an omni-directional wheel, or a combination thereof. Front wheel 122 can be disposed in alignment along forward direction F of second cleaning machine 110 with centerline C_{L} of second cleaning machine 110. Additionally or alternatively, front wheel 122 can be disposed in alignment along forward direction F of second cleaning machine 110 with a center of cleaning assembly 128.

Front wheel 122 can define rotational axis A_{R} about which front wheel 122 rotates as front wheel 122 rolls along a surface (e.g., floor). Front wheel 122 can define pivot axis A_{P} (see e.g., FIG. 2B). Pivot axis A_{P} of front wheel 122 can be a point about which front wheel 122 pivots. As shown in FIG. 2A, pivot axis A_{P} of front wheel 122 can be oriented vertically with respect to second cleaning machine 110 (e.g., vertical being into and out of the page as shown in FIG. 2A). Pivot axis A_{P} can also be oriented perpendicular to pivot axis A_{P} of front wheel 122. In an embodiment, front wheel 122 can be a non-steered wheel. In another embodiment, front wheel 122 can be a steered wheel. Additionally or alternatively, front wheel 122 can be configured to rotate freely about pivot axis A_{P} and/or in a range of direction extending 360° around pivot axis A_{P}.

As shown in FIG. 2B, cleaning assembly 128 includes first cleaning element 130A and second cleaning elements 130B. In another embodiment, cleaning assembly 128 can include one or more than two (e.g., three) cleaning elements.

First cleaning element 130A can define rotational axis B_{R} about which first cleaning element 130A rotates. In FIG. 2B, rotational axis B_{R} is shown as into and out of the page. In an embodiment, rotational axis B_{R} can be disposed approximately perpendicular with rotational axis A_{R} of front wheel 122. Additionally or alternatively, rotational axis B_{R} can be disposed approximately parallel to pivot axis A_{P} of front wheel 122.

In an embodiment, front wheel 122 can be disposed forward along forward direction F of second cleaning machine 110 of rear wheel assembly 124. In another embodiment, front wheel 122 can be positioned on or near a front of second cleaning machine 110 (e.g., with the front of second cleaning machine 110 being disposed towards the left in FIGS. 2A and 2B).

In an embodiment, front wheel 122A can be free to rotate 360°. In another embodiment, front wheel 122A can be configured to at least one of pivot, swivel, or a combination thereof about a respective vertical axis (e.g., up-and-down as shown in FIG. 2A). For example, as shown in FIG. 2B, front wheel 122 can pivot or swivel about pivot axis A_{P}. Additionally, front wheel 122 can support a weight of the front of second cleaning machine 110. In an embodiment, front wheel 122 can be a non-steered wheel. In another embodiment, front wheel 122 can be a steered wheel.

In an embodiment, first rear wheel 126A can be operably connected to drive unit 136 via first rear axle 134A and/or second rear wheel 126B can be operably connected to drive unit 136 via second rear axle 134B. In an embodiment, each wheel of first rear wheel 126A and second rear wheel 126B can be configured to be driven independently of the other rear wheel. For example, each wheel of first rear wheel 126A and second rear wheel 126B can be driven at different rates and/or directions of rotation to cause movement and/or turning of second cleaning machine 110. In an embodiment, the relative positioning between and the drive functionality of first rear wheel 126A and second rear wheel 126B can cause first cleaning machine to rotate about rotation point P_{R} that is defined by rear wheel assembly 124. In an embodiment, rotation point P_{R} can be disposed at an intersection of centerline C_{L} of second cleaning machine 110 and at least one of a rotational axis of first rear axle 134A or a rotational axis of second rear axle 134B.

Second cleaning machine 110 with front wheel 122 and rear wheel assembly 124 presents an independently controlled dual rear-drive wheel configuration that provides both propulsion and steering for second cleaning machine 110. With rear wheel assembly 124 causing first cleaning machine to rotate about rotation point P_{R}, the combination of front wheel 122 and rear wheel assembly 124 enables steering functionality that more closely resembles typical steered arrangements involving front-steered wheels. Additionally, front wheel 122 (e.g., caster or omni-directional wheel) is utilized in the front of second cleaning machine 110 to support the weight of the front of second cleaning machine 110. In view of these features, second cleaning machine 110 gives an operator a sensation of utilizing a more familiar front-steered machine configuration.

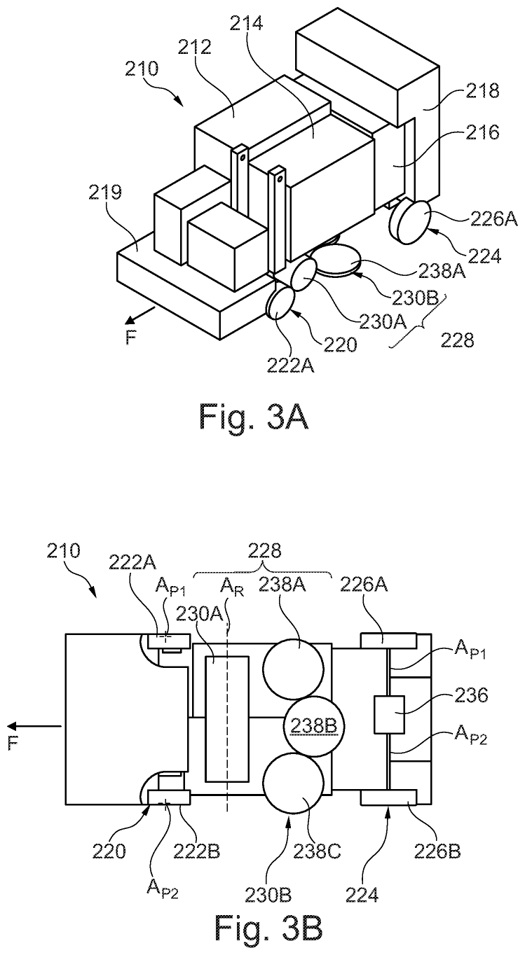

FIG. 3A shows a perspective view of a block model of third cleaning machine 210 with operator area 212, power source 214, solution tank 216, recovery tank 218, hopper 219, front wheel assembly 220 (including first front wheel 222A and second front wheel 222B), rear wheel assembly 224 (including first rear wheel 226A) and cleaning assembly 228 (including first cleaning element 230A and second cleaning element 230B (with first scrubber 238A)). FIG. 3B shows a bottom view of the block model of third cleaning machine 210 with front wheel assembly 220 (including first front wheel 222A and second front wheel 222B), rear wheel assembly 224 (including first rear wheel 226A and second rear wheel 226B), cleaning assembly 228 (including first cleaning element 230A and second cleaning element 230B (with first scrubber 238A, second scrubber 238B, and third scrubber 238C)), first rear axle 234A, second rear axle 234B, and drive unit 236. FIGS. 3A and 3B also include forward direction F which represents an intended direction of use of third cleaning machine 210. FIGS. 3A and 3B are discussed in tandem.

As discussed herein, descriptions of components of third cleaning machine 210 correspond to the same or similar components of first cleaning machine 10 as discussed with the respect to FIGS. 1A and 1B and second cleaning machine 110 as discussed with the respect to FIGS. 2A and 2B. In view of this, components of third cleaning machine 210 are denoted with character reference numerals that are 200 more than the same or similar elements of first cleaning machine 10 and that are 100 more than the same or similar elements of second cleaning machine 110. In this way, descriptions provided with respect to first cleaning machine 10 and second cleaning machine 110 can also describe the corresponding elements of third cleaning machine 210 shown in and discussed with respect to FIGS. 3A and 3B.

Hopper 219 can include a tank or bin for collecting and/or storing material. In an embodiment, hopper 19 can be a bin that defines an opening or cavity for collecting debris and/or dirt received from at least one of first cleaning element 230A, second cleaning element 230B, or a combination thereof.

In an embodiment, first cleaning element 230A can include a single broom (e.g., with a plurality of bristles), such as a cylindrical brush or sweeper. First cleaning element 230A can define rotational axis A_{R} about which first cleaning element 230A rotates. Rotational axis A_{R} of first cleaning element 230A can be disposed parallel to the up and down directions as shown in FIG. 3B. In an embodiment, rotational axis A_{R} of first cleaning element 230A can be disposed approximately perpendicular to at least one of first pivot axis A_{P1} of first front wheel 222A or second pivot axis A_{P2} of second front wheel 222B.

In an embodiment, second cleaning element 230B can include a plurality of cleaning elements. For example, second cleaning element can include first scrubber 238A, second scrubber 238B, and third scrubber 238C. In other embodiment, second cleaning element 230B can include less than or more than three cleaning elements (e.g., scrubbers as shown in FIGS. 3A and 3B).

At least one of first scrubber 238A, second scrubber 238B, and third scrubber 238C can include a disc or pad with a plurality of smaller cleaning elements (e.g., bristles, sponges, micro-fibers, etc.) configured to remove dirt from a cleaning surface (e.g., floor).

In another embodiment, third cleaning machine can include hopper 219 and first cleaning element 230A and also exclude a second cleaning element (e.g., disc(s), shown as second cleaning element 230B in FIGS. 3A and 3B). In yet another embodiment, third cleaning machine 210 can include second cleaning element 230B and also exclude a first cleaning element 230A (e.g., a cylindrical rotating broom or brush, shown as first cleaning element 230A in FIGS. 3A and 3B).

In an embodiment, first cleaning element 230A can be disposed forward along forward direction F of second cleaning element 230B. Additionally or alternatively, first cleaning element 230A can be disposed backward along forward direction F of front wheel assembly 220. Additionally, first cleaning element 230A can be disposed as a counter-rotating broom such that a bottom of first cleaning element 230A spins towards a front of third cleaning machine 210 during operation of third cleaning machine 210.

In an embodiment, third cleaning machine 210 can incorporate a direct-throw functionality via first cleaning element 230A. For example, during operation of third cleaning machine 210, first cleaning element 230A can sweep debris and particulate (with or without the assistance of a solution) from the cleaning surface and towards hopper 219. In particular, first cleaning element 230A can sweep debris and/or particulate into a portion of hopper 219. Additionally or alternatively, second cleaning element 230B can at least one of scrub, wash, or a combination thereof (with or without the assistance of a solution) the cleaning surface.

Similar to first cleaning machine 10 and second cleaning machine 110 discussed above, third cleaning machine 210 with front wheel assembly 220 and rear wheel assembly 224 provides a cleaning machine with zero-turn capabilities as well as enables a more familiar turning sensation for the user.

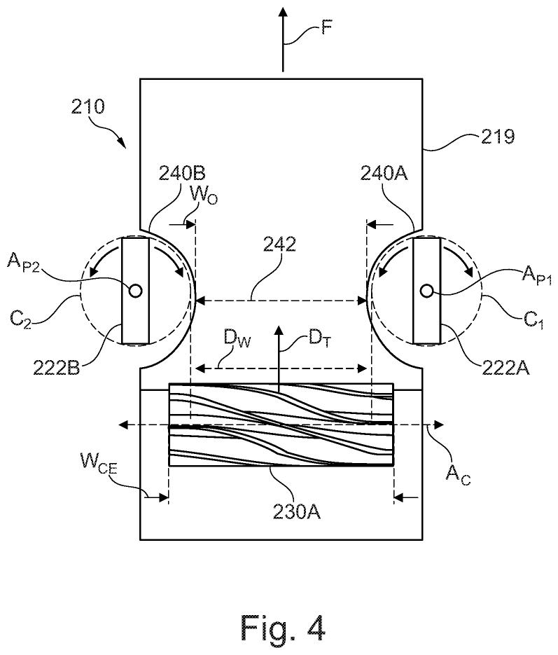

FIG. 4 shows a bottom view of a portion of third cleaning machine 210 that includes hopper 219, front wheel assembly 220, and first cleaning element 230A.

In an embodiment, hopper 219 can include first sidewall 240A and second sidewall 240B. First sidewall 240A and second sidewall 240B can be disposed on opposite sides of third cleaning machine 210 from each other. First sidewall 240A can be curved and can be oriented concave away from second sidewall 240B. Second sidewall 240B can be curved and can be oriented concave away from first sidewall 240A.

Additionally or alternatively, first sidewall 240A can include a first concavity that is oriented concave away from second sidewall 240B. Second sidewall 240B can include a second concavity that is oriented concave away from first sidewall 240A. First front wheel 222A can be disposed partially within the first concavity of first sidewall 240A. Second front wheel 222B is disposed partially within the second concavity of second sidewall 240B.

Hopper 219 can define opening 242. Opening 242 can be an inlet for hopper 219. In an embodiment, opening 242 extends from first sidewall 240A to second sidewall 240B. Opening 242 is disposed to receive particulate and debris from first cleaning element 230A during operation of third cleaning machine 210. Opening 242 can include width W_{O} that extends from one side of opening 242 to the other side of opening 242 along a transverse direction of third cleaning machine 210 (e.g., transverse direction shown as from a left side of opening 242 to a right side of opening 242 in FIG. 4). Additionally or alternatively, Width W_{O} of opening 242 can be defined between a point along first sidewall 240A that is closest to second sidewall 240B and a point along second sidewall 240B that is closest to first sidewall 240A.

First front wheel 222A can define a first circumference C₁ of rotation and second front wheel 222B can define a second circumference C₂ of rotation. A distance between inward moist points of each of first circumference C₁ of rotation and second circumference C₂of rotation can be defined as distance D_{W}.

In an embodiment, first cleaning element 230A can define throw direction D_{T}representative of a direction that particulate and/or debris is thrown from first cleaning element 230A during operation of third cleaning machine 210. Additionally or alternatively, throw direction D_{T} can be in the same direction as forward direction F (as shown in FIGS. 1A-3B).

First cleaning element 230A can also define width W_{CE} from a first end of first cleaning element 230A to an opposite end of first cleaning element 230A. Additionally or alternatively, width W_{CE} of First cleaning element 230A can extend from a first end of first cleaning element 230A to an opposite end of first cleaning element 230A along centerline axis A_{C} of first cleaning element 230A.

In an embodiment, width W_{O} of opening 242 can be less than distance D_{W}between first circumference C₁ of rotation and second circumference C₂ of rotation. Additionally or alternatively, width of first cleaning element 230A is greater than width W_{O} of opening 242 of hopper 219.

First sidewall 240A enables first front wheel 222A rotate about first pivot axis A_{P1} in such a way that prevents first front wheel 222A from coming into contact with a wall of hopper 219. Likewise, second sidewall 240B enables second front wheel 222B to rotate about second pivot axis A_{P2} in such a way that prevents second front wheel 222B from coming into contact with a wall of hopper 219. Additionally, the placement of first front wheel 222A and second front wheel 222B relative to a center of hopper 219 allows third cleaning machine 210 to have a narrow profile as when compared with front wheels being disposed outside of straight sidewalls of a hopper of an alternate cleaning machine.

Any of the cleaning machines in the embodiments described herein can also include a squeegee mounted to the cleaning machine. In any of the embodiments, a squeegee can be mounted behind the cleaning element (e.g., relative to the intended direction of use of the cleaning machine) to collect liquid from the cleaning surface. Additionally or alternatively, any of the embodiments discussed herein can include one or more steered front wheels if place of or in addition to the front wheels (e.g., 22A, 22B, 122A, 122B, 222A, or 222B) discussed herein.

### Various Notes & Examples

A cleaning machine for cleaning along an intended direction of use includes a drive assembly, a cleaning element, and a multi-directional wheel. The drive assembly includes a motor and a pair of drive wheels operable connected to the motor. Each wheel of the pair of wheels can be configured to be driven independently of the other wheel. The cleaning element can be disposed forward of the pair of drive wheels along the intended direction of use of the cleaning machine. The multi-directional wheel disposed forward along the intended direction of use of the pair of drive wheels. The multi-directional wheel can define a pivot axis and can be configured to swivel about the pivot axis in a range of direction extending 360°.

Each of these non-limiting examples can stand on its own or can be combined in various permutations or combinations with one or more of the other examples.

Optionally, the multi-directional wheel can comprise a first multi-directional wheel on a first side of the cleaning machine; and/or a second multi-directional wheel disposed on a second side of the cleaning machine opposite the first side of the cleaning machine.

Optionally, the cleaning machine can define a space, a platform, or a combination thereof configured for a user to occupy during use of the cleaning machine, wherein the space, the platform, or the combination thereof can be disposed in front along the intended direction of use of the cleaning machine of the pair of drive wheels.

Optionally, the space, the platform, or the combination thereof configured for the user to occupy during use of the cleaning machine can be disposed rearward along the intended direction of use of the cleaning machine of the multi-directional wheel.

Optionally, the cleaning element can comprise a scrubber and/or the multi-directional wheel can be disposed forward of the scrubber along the intended direction of use of the cleaning machine.

Optionally, the scrubber can define a rotational axis about which the scrubber rotates, wherein the pivot axis of the multi-directional wheel can be disposed approximately parallel with the rotational axis of the scrubber.

Optionally, the scrubber can comprise a cylindrical brush, wherein the cylindrical brush can define a rotational axis about which the cylindrical brush rotates, wherein the pivot axis of the multi-directional wheel can be disposed approximately perpendicular to the rotational axis of the cylindrical brush.

Optionally, the cleaning machine can further comprise a hopper configured to receive debris from the cleaning element, wherein the hopper can comprise: a bin defining a cavity therein; and an inlet defining an opening disposed to receive debris from the cleaning element, wherein the opening can define a width extending along a transverse direction of the cleaning machine; wherein the cleaning element can define a width, wherein the width of the cleaning element can be greater than the width of the opening of the inlet of the hopper.

Optionally, the cleaning element can comprise a broom with a plurality of bristles, wherein the width of the cleaning element can be defined along a centerline axis of the broom from a first end of the broom to a second end of the broom.

Optionally, the inlet of the hopper can comprise a first sidewall and a second sidewall, wherein the first sidewall and the second sidewall can be disposed on opposite sides of the cleaning machine from each other, wherein the first sidewall can be curved and can be oriented concave away from the second sidewall, wherein the second sidewall can be curved and can be oriented concave away from the first sidewall, wherein the width of the opening of the inlet can be defined between a point along the first sidewall closest to the second sidewall and a point along the second sidewall closest to the first sidewall.

Optionally, the multi-directional wheel can comprise: a first multi-directional wheel on a first side of the cleaning machine; and a second multi-directional wheel disposed on a second side of the cleaning machine opposite the first side of the cleaning machine; wherein the first sidewall can comprise a first concavity that can be oriented concave away from the second sidewall, wherein the second sidewall can comprise a second concavity that can be oriented concave away from the first sidewall, wherein the first multi-directional wheel can be disposed partially within the first concavity of the first sidewall, wherein the second multi-directional wheel can be disposed partially within the second concavity of the second sidewall; wherein the width of the opening of the inlet can be defined between a point along first sidewall closest to the second sidewall and a point along second sidewall closest to the first sidewall.

Optionally, the motor can comprise a pair of motors, wherein a first drive wheel of the pair of wheels can be mounted to a first motor of the pair of motors, wherein a second wheel of the pair of drive wheels can be mounted to a second motor of the pair of motors.

A propulsion system for a cleaning machine with a cleaning element can include a driving assembly and a multi-directional wheel. The driving assembly can be disposed rearward of the cleaning element of the cleaning machine along an intended direction of use of the cleaning machine. The driving assembly can include a motor and a pair of drive wheels operably connected to the motor. Each wheel of the pair of drive wheels can be configured to be driven independently of the other drive wheel. The multi-directional wheel can be disposed forward along the intended direction of use of the cleaning machine of the pair of drive wheels. The multi-directional wheel can define a pivot axis and can be configured to swivel 360° about the pivot axis.

Each of these non-limiting examples can stand on its own or can be combined in various permutations or combinations with one or more of the other examples.

Optionally, the motor can comprise a pair of motors, wherein a first drive wheel of the pair of wheels can be mounted to a first motor of the pair of motors, wherein a second wheel of the pair of drive wheels can be mounted to a second motor of the pair of motors.

Optionally, the multi-directional wheel can comprise a first multi-directional wheel and/or a second multi-directional wheel.

Each of these non-limiting examples can stand on its own or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

We claim:

1. A cleaning machine for cleaning along an intended direction of use, the cleaning machine comprising:
a driving assembly comprising:
a motor; and
a pair of drive wheels operably connected to the motor, wherein each wheel of the pair of wheels is configured to be driven independently of the other wheel;
a cleaning element disposed forward of the pair of drive wheels along the intended direction of use of the cleaning machine; and
a multi-directional wheel disposed forward along the intended direction of use of the pair of drive wheels,
wherein the multi-directional wheel defines a pivot axis, and
in a range of direction extending 360°.

2. The cleaning machine of claim 1, wherein the multi-directional wheel comprises:
a first multi-directional wheel on a first side of the cleaning machine; and
a second multi-directional wheel disposed on a second side of the cleaning machine opposite the first side of the cleaning machine.

3. The cleaning machine of claim 1, wherein the cleaning machine defines a space, a platform, or a combination thereof configured for a user to occupy during use of the cleaning machine, wherein the space, the platform, or the combination thereof is disposed in front along the intended direction of use of the cleaning machine of the pair of drive wheels.

4. The cleaning machine of claim 3, wherein the space, the platform, or the combination thereof configured for the user to occupy during use of the cleaning machine is disposed rearward along the intended direction of use of the cleaning machine of the multi-directional wheel.

5. The cleaning machine of claim 1, wherein the cleaning element comprises a scrubber, and wherein the multi-directional wheel is disposed forward of the scrubber along the intended direction of use of the cleaning machine.

6. The cleaning element of claim 5, wherein the scrubber defines a rotational axis about which the scrubber rotates, wherein the pivot axis of the multi-directional wheel is disposed approximately parallel with the rotational axis of the scrubber.

7. The cleaning element of claim 5, wherein the scrubber comprises a cylindrical brush, wherein the cylindrical brush defines a rotational axis about which the cylindrical brush rotates, wherein the pivot axis of the multi-directional wheel is disposed approximately perpendicular to the rotational axis of the cylindrical brush.

8. The cleaning machine of claim 1, further comprising a hopper configured to receive debris from the cleaning element, wherein the hopper comprises:
a bin defining a cavity therein; and
an inlet defining an opening disposed to receive debris from the cleaning element, wherein the opening defines a width extending along a transverse direction of the cleaning machine,
wherein the cleaning element defines a width, wherein the width of the cleaning element is greater than the width of the opening of the inlet of the hopper.

9. The cleaning machine of claim 8, wherein the cleaning element comprises a broom with a plurality of bristles, wherein the width of the cleaning element is defined along a centerline axis of the broom from a first end of the broom to a second end of the broom.

10. The cleaning machine of claim 8, wherein the inlet of the hopper comprises a first sidewall and a second sidewall, wherein the first sidewall and the second sidewall are disposed on opposite sides of the cleaning machine from each other, wherein the first sidewall is curved and is oriented concave away from the second sidewall, wherein the second sidewall is curved and is oriented concave away from the first sidewall, wherein the width of the opening of the inlet is defined between a point along the first sidewall closest to the second sidewall and a point along the second sidewall closest to the first sidewall.

11. The cleaning machine of claim 8,
wherein the multi-directional wheel comprises:
a first multi-directional wheel on a first side of the cleaning machine; and
a second multi-directional wheel disposed on a second side of the cleaning machine opposite the first side of the cleaning machine;
wherein the inlet of the hopper comprises a first sidewall and a second sidewall;
wherein the first sidewall comprises a first concavity that is oriented concave away from the second sidewall, wherein the second sidewall comprises a second concavity that is oriented concave away from the first sidewall, wherein the first multi-directional wheel is disposed partially within the first concavity of the first sidewall, wherein the second multi-directional wheel is disposed partially within the second concavity of the second sidewall; and
wherein the width of the opening of the inlet is defined between a point along first sidewall closest to the second sidewall and a point along second sidewall closest to the first sidewall.

12. The propulsion system of claim 1, wherein the motor comprises a pair of motors, wherein a first drive wheel of the pair of wheels is mounted to a first motor of the pair of motors, wherein a second wheel of the pair of drive wheels is mounted to a second motor of the pair of motors.

13. A propulsion system for a cleaning machine with a cleaning element, the propulsion system comprising:
a driving assembly disposed rearward of the cleaning element of the cleaning machine along an intended direction of use of the cleaning machine, the driving assembly comprising:
a motor; and
a pair of drive wheels operably connected to the motor, wherein each wheel of the pair of drive wheels is configured to be driven independently of the other drive wheel; and
a multi-directional wheel disposed forward along the intended direction of use of the cleaning machine of the pair of drive wheels,
wherein the multi-directional wheel defines a pivot axis, and
wherein the multi-directional wheel is configured to swivel 360° about the pivot axis.

14. The propulsion system of claim 13, wherein the motor comprises a pair of motors, wherein a first drive wheel of the pair of wheels is mounted to a first motor of the pair of motors, wherein a second wheel of the pair of drive wheels is mounted to a second motor of the pair of motors.

15. The propulsion system of claim 13, wherein the multi-directional wheel comprises a first multi-directional wheel and a second multi-directional wheel.
